(19) United States
(12) Patent Application Publication
(10) Pub. No.: US 2004/0162900 A1
(43) Pub. Date: Aug. 19, 2004

(54) Distributed content management system

(76) Inventors: Tim Bucher, Los Altos, CA (US); Tim Sullivan, Portola Valley, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/736,160

(22) Filed: Dec. 15, 2003

Related U.S. Application Data
(60) Provisional application No. 60/435,317, filed on Dec. 17, 2002.

(51) Int. Cl. G06F 15/16; G06F 15/173

(52) U.S. Cl. 709/225; 709/229

(57) ABSTRACT

Systems and methods for implementing content management in a network computing environment. The content management is concerned with, for example, content backup, storage, and sharing, local and remote accessibility, security, content consistency, and other network operations. The systems and method incorporate a network appliance in a local area network. The appliance communicates with the various devices in the network and, in at least some embodiments, with a remote content management service. In addition, computing devices in the local area network have installed content management software to allow the network appliance to access, copy for backup, and/or manipulate content on the computing device. The software of the network appliance communicates with the software installed on the client computers to configure itself and the network automatically or with relatively little user input.

### CROSS-REFERENCE TO RELATED APPLICATIONS

This application claims the benefit of U.S. Provisional Application No. 60/435,317, filed Dec. 17, 2002, and entitled DISTRIBUTED CONTENT MANAGEMENT SYSTEM, which is hereby incorporated herein by reference.

### BACKGROUND OF THE INVENTION

1. The Field of the Invention

The present invention relates generally to network computing environments and related hardware and software. More particularly, embodiments of the present invention relate to systems and methods for implementing scaled and comprehensive content management in a network computing environment.

2. The Relevant Technology

Computer networks continue to proliferate due to declining costs, increasing performance of computer and networking equipment, and increasing demand for communication bandwidth. Client networks, including wide area networks (“WANs”) and local area networks (“LANs”), allow increased productivity and utilization of distributed computers or stations through the sharing of resources, the transfer of data, and the processing of data at the most efficient locations.

Moreover, as organizations and individuals have recognized the economic benefits of using client networks, network applications such as electronic mail, voice and data transfer, host access, and shared and distributed databases, are increasingly used as a means to increase user productivity. This increased demand, together with the growing number of distributed computing resources, has resulted in a rapid expansion of the number of installed networks. For example, while the use of client networks was initially confined primarily to business applications, such use has more recently expanded and now commonly extends to home environments as well.

While computing devices and computer networks have proven quite popular, many small to medium sized businesses lack the technical expertise and/or other resources to effectively manage their network content. For example, many users lack reliable systems, methods and software to facilitate remote access to content residing on the network. This is particularly problematic for those businesses with employees who travel extensively, as well as for businesses with more than one operating site.

Content sharing in such environments is problematic as well. In particular, files and other content created by a particular user and/or resident in a particular location on the network are often not readily accessible to other users. Moreover, such other users typically lack reliable systems and software to search for and locate such content, and may not even be aware of the existence of such content. In addition, different versions of the same data may reside in different locations on the network. This can lead to inconsistencies and errors because it may be difficult to ensure that users are working on the correct version of the data.

Another problem concerning network content, particularly software, is that it is often the case that different versions of a particular program reside on the network. Because different versions of a particular program may not be compatible with each other and/or may have different feature sets, the existence of different program versions on the network can impair network operations and may hamper content management efforts such as content tracking. Moreover, the presence of different versions of the same program on the network often complicates efforts to ensure compliance with applicable licensing requirements.

Yet other content related problems concern the protection and security of network content. In particular, many networks lack the systems, hardware and software to implement a systematic approach to backing up content. As a result, some content is backed up while other content is not. Incomplete or non-existent content backups may foreclose the ability to reconstruct or recover content if a catastrophic network event occurs, or in the event that the content becomes infected with a virus or is subjected to unauthorized access and modification.

With reference to FIG. 1, a large number of devices are currently implemented for use by local area networks (LANs), such as LAN 10. These devices include, for example, a fire server 12, a wireless LAN device 14, a router 16, a firewall 18, and a modem 20. The modem 20 connects LAN 10 to the Internet 22, or other network. Obviously these numerous devices can consume a great deal of time and resources to setup and maintain. In addition, the use of these devices creates the need for a variety of distinct software modules to be installed and maintained.

Because of the inherent complexity associated with the configuration, construction, and maintenance of a computer network, the result is often an improperly configured network that operates inefficiently or incompletely. Such problems hamper content management because they limit the opportunity to bring the full power, functionality and capabilities of the network, and related systems, devices, hardware, and software, to bear on content management issues. Moreover, such complexity tends to divert resources that could otherwise be applied to content management.

In addition, some users have attempted to implement file-sharing and related functionality by using electronic mail, or “email,” to transmit files to other users. However, sharing files in this way is problematic, at least because email software is generally not designed or intended for use in implementing file sharing schemes. For each content file or group of content files desired to be sent by email, the sender must specify in the email the name of each of the recipients to whom such content files will be sent. This approach to file sharing can be frustrating and time-consuming, particularly for users that frequently disseminate a variety of different content types to different groups of recipients. Moreover, attaching content files to an email can slow the operation of the email program and may, in some instances, result in corrupted or truncated content files.

Further, some content files are too large to be sent by email and so must be loaded on electronic media that is then physically transported to the intended recipient. Such manual processes are time-consuming, expensive, and unreliable, particularly where a large amount of content or a large number of files is desired to be transferred. This illustrates one of the ways that different versions of the same data can be created. It may become difficult, for example, to identify the version of the data that incorporates all changes.

Yet other file-sharing schemes have been implemented in the form of servers and Internet-based storage sites. However, these types of systems and environments typically lack effective and reliable systems and software to search for and locate content. Such limited search capabilities compromise the ability of users to locate, access and share content. A further problem with the use of servers and Internet-based storage sites as a vehicle for implementation of file sharing schemes is that both servers and Internet storage sites can be quite expensive to purchase, use and maintain. Moreover, the storage capabilities of servers and Internet storage sites are typically rather limited. Content located at those sites may be vulnerable to hacking or other unauthorized access.

Not only does the proliferation of content have implications with respect to content backup procedures and file sharing, but it is often the case that users desire to be able to effectively and reliably access such content from remote locations. Various types of hardware and software have been devised to this end, but have not proven particularly effective in implementing such remote content access functionality.

Accordingly, there is an increasing need for improved network systems and devices to simplify the setup and organization of local area networks. Such networks have a need for improved data sharing, data backup, and remote accessibility features as well.

### BRIEF SUMMARY OF THE INVENTION

The present invention relates to systems and methods for implementing content management in a network computing environment. The content management is concerned with, among other things, content backup, storage, and sharing, local and remote accessibility, security, content consistency, and other network operations.

In one exemplary embodiment of the invention, a content management system, exemplarily embodied as a combination of hardware and software, is provided that includes one or more appliances configured to be deployed, for example, in a primary local area network (LAN) and a remote network. The appliance(s) communicate with the various devices in the corresponding networks and, in at least some embodiments, with a remote content management service. Each appliance includes, or accesses, various systems, software and devices that facilitate content management within the corresponding network(s). In addition, computing devices in the corresponding networks have installed content management software to allow the network appliance to access, copy for backup, and/or manipulate content on the computing device.

By way of example, each appliance may have an associated database and policy engine that incorporates various rules for the handling of content created on, or sent to, the network. Exemplary rules relate to the distribution, storage, sharing, and a secure and reliable backup of such content, on both local and remote devices. The appliances are also configured to create, update, and maintain databases located at remote locations, and also to permit remote users to access local content, either directly, or by way of an Internet-based service.

A network appliance according to the invention can be installed in a network in a relatively simple manner and requires little detailed knowledge of computer networks or wireless communication protocols. According to one embodiment of the invention, the installation of a network appliance can be performed simply by placing the wireless network appliance in proximity to client computers that are equipped with wireless interfaces, powering on the network appliance, and installing client software on the client computers. The software of the network appliance communicates with the software installed on the client computers to configure itself and the network automatically or with relatively little user input. This configuration can involve establishing wireless communication between the client computers and the network appliance, initiating the process of enabling data to be shared between client computers and backed up, and providing other network services, such as connectivity to the Internet and data sharing and redundancy services between the local network and a remote service or remote computers.

Accordingly, a first embodiment of the invention is a content management system. The system generally includes a network appliance configured to be deployed in a local area network and/or remote office network and a computing device. The appliance is configured to communicate with a computing device in the corresponding network(s) and each appliance includes, or accesses, various systems, software and devices that facilitate content management within the corresponding network(s); and a computing device. The computing device comprises a computer readable medium carrying computer executable instructions which enable the computing device to, upon placement of the network appliance in communication with the computing device, provide permission to the network appliance to access selected content on the computing device.

Another example embodiment of the invention is also a content management system. This system generally includes: a wireless enabled network appliance configured to be deployed in a local area network, a wireless enabled computing device, and a remote content management service. The appliance includes system software which enables the appliance comprises various systems, software and devices that facilitate content management within the network. The wireless enabled computing device includes a computer readable medium carrying computer executable instructions which enable the computing device to, upon placement of the network appliance in wireless range of the computing device, provide permission to the network appliance to access selected content on the computing device. The remote content management service is configured to communicate with and interface between the network appliance and remote users and/or systems such that the remote users and/or systems can access content stored on the network appliance and/or the computing device.

Yet another example embodiment of the invention is a method for providing automated data storage and file sharing services. This method generally includes the acts of: providing a wireless-enabled computing device within a local area network; installing software on the computing device which enables the computing device to engage in wireless communications with a content management network appliance; and placing a content management network appliance within wireless range of the wireless-enabled computing device, whereby the wireless-enabled computing device and the content management network appliance automatically initiate communication with each other.

Finally, yet another example embodiment of the invention is a computer program product for implementing a method suitable for use on a wireless enabled computing device in a local area network. The computer program product is a computer readable medium carrying computer executable instructions for performing a method. The method generally includes: configuring wireless systems on the computing device to monitor for a wireless enabled network appliance; upon the wireless system on the computing device identifying a wireless enabled network appliance, verifying whether the computing device has permission to access the computing device; and upon verifying that the wireless enabled network appliance has permission to access the computing device, providing access to selected content on the computing device to the network appliance.

These and other advantages and features of the present invention will become more filly apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates prior art devices which may be implemented in a network environment to establish a local area network;

FIG. 2 illustrates an exemplary network environment for implementing embodiments of the present invention;

FIG. 3 illustrates a schematic diagram of one embodiment of a system according to the invention by which a network appliance is used in a local area network;

FIG. 4 is another schematic diagram that illustrates aspects of an exemplary computer network operating environment suitable for embodiments of the invention;

FIG. 5 illustrates aspects of a system architecture according to embodiments of the invention; and

FIG. 6 illustrates a flow diagram depicting one suitable method for implementing aspects of one embodiment of the invention.

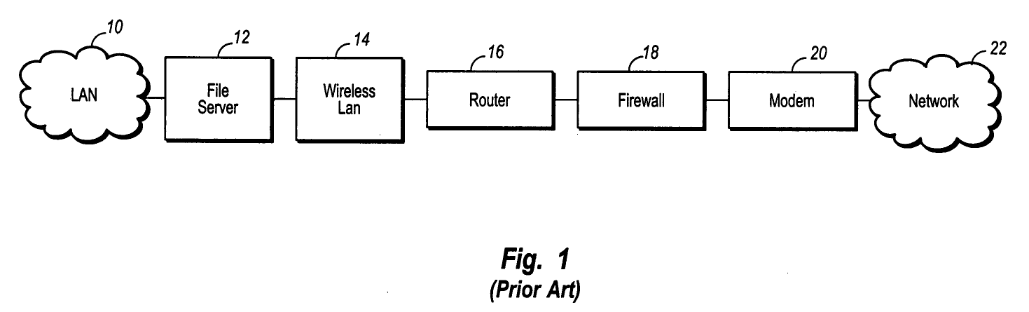

### DETAILED DESCRIPTION OF THE PREFERRED EMBODIMENTS

Embodiments of the present invention relate to systems and methods for implementing content management in a network computing environment. The content management is concerned with, among other things, content backup, storage, and sharing, local and remote accessibility, security, content consistency, and other network operations. As used herein, the term “content” includes, among other things, documents, data, files, information, software, and any other electronic materials in conjunction with which it may be useful or desirable to backup, share in a network environment, or make accessible from a remote location.

In one exemplary embodiment of the invention, a content management system, exemplarily embodied as a combination of hardware and software, is provided that includes one or more appliances configured to be deployed, for example, in a main office local area network (LAN) or a remote office network. The appliance(s) communicate with the various devices in the corresponding networks and, in at least some embodiments, with a remote content management service. Each appliance includes, or accesses, various systems, software and devices that facilitate content management within the corresponding network(s). In addition, computing devices in the corresponding networks have installed content management software to allow the network appliance to access, copy for backup, and/or manipulate content on the computing device.

By way of example, each appliance may have an associated database and policy engine that incorporates various rules for the handling of content created on, or sent to, the network. Exemplary rules relate to the distribution, storage, sharing, and secure and reliable backup of such content, on both local and remote devices. The appliances are also configured to create, update, and maintain databases located at remote locations, and also to permit remote users to access local content, either directly, or by way of an Internet-based service.

A network appliance according to the invention can be installed in a network in a relatively simple manner and requires little detailed knowledge of computer networks or wireless communication protocols. According to one embodiment of the invention, the installation of a network appliance can be performed simply by placing the wireless network appliance in proximity to client computers that are equipped with wireless interfaces, powering on the network appliance, and installing client software on the client computers. The software of the network appliance communicates with the software installed on the client computers to configure itself and the network automatically or with relatively little user input. This configuration can involve establishing wireless communication between the client computers and the network appliance, initiating the process of enabling data to be shared between client computers and backed up, and providing other network services, such as connectivity to the Internet and data sharing and redundancy services between the local network and a remote service or remote computers.

Reference will now be made to the drawings to describe various aspects of exemplary embodiments of the invention. It is to be understood that the is drawings are diagrammatic and schematic representations of such exemplary embodiments, and are not limiting of the present invention, nor are they necessarily drawn to scale.

In the following description, numerous specific details are set forth in order to provide a thorough understanding of the present invention. It will be obvious, however, to one skilled in the art that the present invention may be practiced without these specific details. In other instances, well-known aspects of network systems have not been described in particular detail in order to avoid unnecessarily obscuring the present invention.

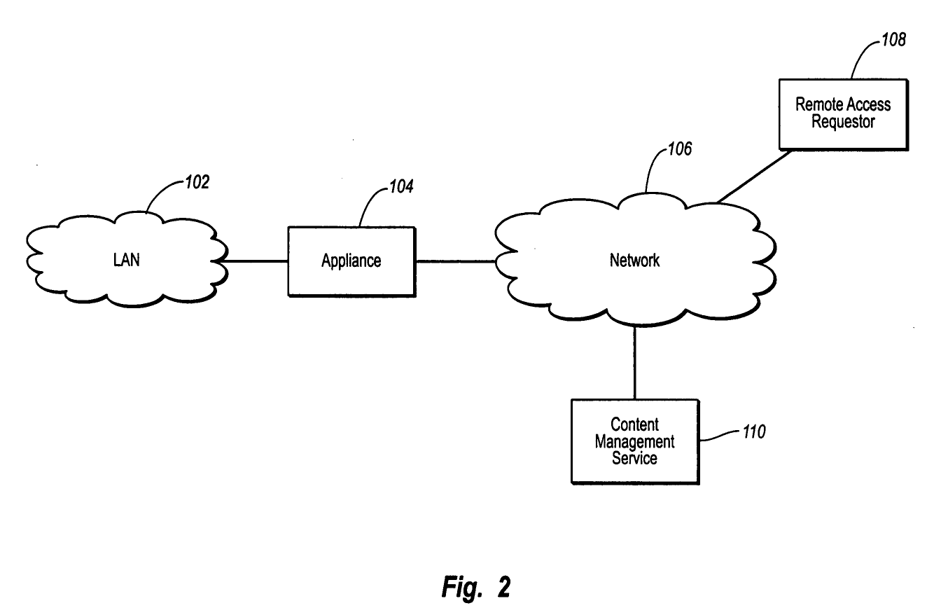

Reference is first made to FIG. 2, which is a block diagram of a system for implementing embodiments of the invention. In the networked system, a LAN 102 has an attached network appliance 104 that is used to monitor and control communications both within the LAN 102 and between LAN 102 and network 106, as further described herein. While LAN 102 can be essentially any local network, the invention is particularly well-suited to LANs that are established in a home network, a small-office network, or a home office network. Network 106 may be, for example, the Internet, a wide area network (WAN), or any other network system as is commonly known or may be developed.

The depicted embodiment includes two of the typical devices external to the LAN 102 that may request access to, or receive access requests from, the LAN 102 via the network appliance 104 and network 106. These are a remote access requestor 108 and a web-based content management service 110. The service 110 is a web-based service that is responsive to the requests of numerous remote users and devices, such as remote access requestor 108 and LAN 102, and may be used to coordinate communications between the appliance 104 and remote devices and networks. The requestor 108, may be a remote user, such as an individual user of an employee, who typically operates within LAN 102 but is currently working at a remote location; a trusted third party who is granted access to LAN 102; a remote LAN, such as a remote office LAN in a corporation that has more than one office; or any another service or application that is seeking access to the LAN, for example to update its databases.

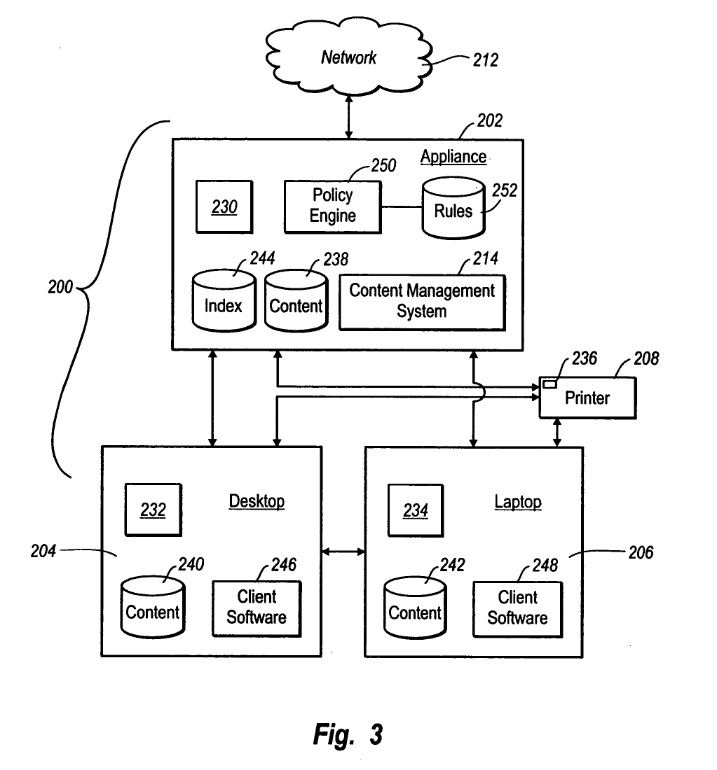

Reference is now made to FIG. 3, which illustrates a block diagram of a distributed appliance-based LAN, designated generally at 200. Network 200 may be configured similarly to appliance 104 and LAN 102. As depicted, the network 200 includes peripheral devices such as a desktop computer 204, a printer 208, and a laptop computer 206 in communication with a network appliance 202. Of course, the network 200 may contain an arbitrary number of such devices. The network 200 may also include other peripheral electronic devices not discussed herein or depicted in FIG. 3 that are known in the art. As depicted by the various lines in FIG. 3, the devices may be connected directly to appliance 202, directly to each other, and/or in a ring, depending upon the preferred design of the LAN. The appliance 202 may be connected or provide access to an external network, for example network 212.

The network 200 may also be implemented, for example, as a wireless network. Hence, appliance 202 has wireless system 230, desktop computer has wireless device 232, laptop computer has wireless system 234, and printer 208 has wireless system 236. Of course, the network 200 may be only partially wireless, with printer 208 or other devices lacking wireless capabilities.

Generally, a network appliance is a computer device that includes hardware devices and software modules. In this embodiment, network appliance 202 includes a processor that executes the routines in the software modules. An appliance based networking environment utilizes an appliance to perform various services for the computers in the network, such as by operating as a router to distribute data throughout the network, by operating as an Internet gateway, by providing effortless redundant data storage services, enabling data collaboration, enabling data indexing, and the like.

In addition to modules that control the router and gateway functions of the appliance 202, the appliance may also includes modules that perform data storage and network interfacing. A gateway module, for example, distributes data between the peripheral computers connected to the appliance and the Internet. A router module distributes data between each of the peripheral computers connected to the appliance 202. A data storage module may store data from one or more of the peripheral computers. The data stored on the appliance can be used for any purpose such as backup, expansion, or collaboration, both within the local network illustrated in FIG. 3 and within a large area network that includes remote computers connected to the appliance via the Internet. Hence, appliance 202 is depicted with mass storage device 238 for storing content backed up from the network devices, such as from mass storage devices 240, 242 on the desktop and laptop computers. In addition, appliance 202 may have a content index database 244 for storing an index of the content stored on mass storage devices 240, 242 as well as other devices in the network 200.

A content management system 214 also resides on appliance 202, enabling the appliance 202 to exchange data with the peripheral computers connected to the appliance. Similarly, desktop computer 204 and laptop computer 206 contain client software 246 which enables the initial recognition and configuration of appliance 202 in network 200 as well as ongoing data exchange between appliance 202 and the networked computers.

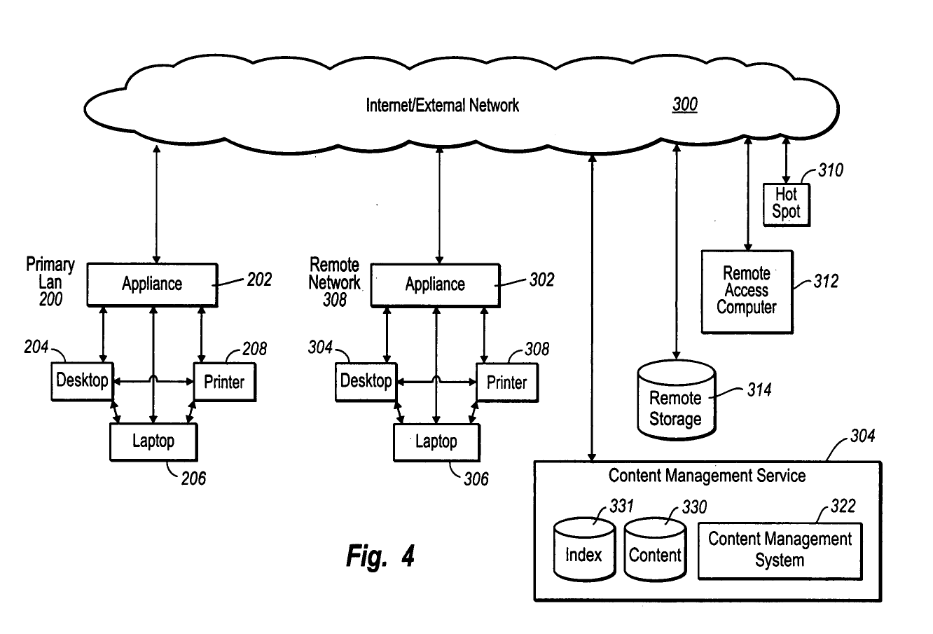

Generally, the client management system 214 on appliance 202, as well as any other software installed on or embedded on appliance 202 serves various functions to coordinate data exchange and manipulation within network 200 or between devices in network 200 and a remote content management service (service 304 in FIG. 4). Such functions may include, for example: file server operations; shared folder synchronization with the devices on network 200; local content backup with versions; coordination of remote content backup and restore, for example with remote database 314 in FIG. 4 or database 330 on service 304 in FIG. 4; content indexing, for example with remote database 331 in FIG. 4, receipt and implementation of software updates from a remote source; built-in firewall; coordination of external firewall; secure communication and authentication with clients and services; DHCP client and server capability; application web interface; computing device recognition and configuration; and appliance and client health monitoring with alerts.

The client software 246 on desktop computer 204 also serves various functions to coordinate data exchange between desktop computer 204 and appliance 202. Initially, upon installation on the client software 246 on a desktop computer 204, the client software 246 configures wireless systems 232 on the desktop computer 204 to monitor for network appliances. Upon recognition of an authorized network appliance 202 and initialization of communication therewith, the client software 246 helps configure the relationship and coordinate the indexing and/or upload of data from desktop computer 204 to appliance 202. In addition, the client software 246 may provide a graphical user interface so that a user can input data and control operations. For example, it may be necessary or desirable to have user input identity data that allows authentication of the appliance or remote users or systems. It may also be desirable to have the user specify which content is available for indexing or upload and to control the extent to which others can view or modify the content. The client software 246 may additionally performs function such as: secure communication and authentication with an appliance; shared folder synchronization; filer versioning and backup; system notifications; and appliance diagnostics.

In one embodiment, as a result of both the client software 246 and the content management system 214, a plug and play system is created whereby a user needs to merely install the client software on a client computer and power-up a network appliance. The wireless capabilities of each device can initiate communications and coordinate setup so that content backup and sharing is implemented with little effort.

In addition to the network capabilities and the other features discussed herein, the network appliances may be otherwise similar to the network appliances disclosed in U.S. Provisional Patent Application Serial No. 60/502,746, entitled “Seamless Scaling of Multiple Appliances,” filed Sep. 12, 2003, which is incorporated herein by reference.

Directing attention now to FIG. 4, details are presented concerning a content management system implemented over various devices connected by the Internet or an external network, denoted generally at 300. In the illustrated embodiment, the content management system includes a main office network 200 including a network appliance 202 connected to various networked devices such as, for example, desktop computer 204, laptop computer 206, and printer 208. In this embodiment, the system is implemented in a client-website computing environment including a content management service website 304 configured for communication with a variety of clients such as the main office network 200, a home/remote office network 308, a “hotspot” 310, a computer 312 configured for remote access, and a remote mass storage device 314.

Both the primary network 200 and home/remote office network 308 include corresponding appliances that are configured to include, or otherwise implement, functionality concerning the content management system. Generally, such appliances may include any system or device capable of implementing the functionality disclosed hereinabove respecting appliance 202.

As noted above, an additional client of the content management service comprises hotspot 310. In general, for users of portable computers equipped for wireless, a hot spot is a location providing Internet connection and virtual private network access from a given location. For example, a business traveler with a laptop equipped for Wi-Fi can look up a local hot spot (access point), contact it, and get connected through its network to reach the Internet and their company remotely with a secure connection. Alternatively, as used herein a hotspot 310 may denote any of various devices through which content can be viewed or accessed, such as in a read-only mode. The hotspot 310 may include locally stored content and/or may simply operate as a “window” on content stored at the content management service website 304. Yet another exemplary client of the content management service comprises a computer 312 that is configured for remote access to the content management service, either by way of a hardwire or wireless connection.

In addition, the remote mass storage device 314 may be used by the content management systems disclosed herein to increase the storage capacity of the systems disclosed herein.

Various aspects of content management may be distributed among the content management service website 304 and one or more of the associated clients. By way of example, the content management system 214 of the appliance 202 may be configured to receive data from the service-based content management system 322 and synchronize the received data on the various devices that comprise the main office network 200. The same arrangement may likewise be implemented with respect to a content management system of home/remote office network 308.

Thus, each of the clients is configured to implement, by way of their respective appliances, certain content management functionalities concerning only their associated devices. Accordingly, in this embodiment the overall synchronization of content among all of the clients is implemented by way of the content management system 322. In this way, content changes or other events occurring within, for example, primary network 200 can be reflected, by operation of the content management system 322, at other clients such as computer 312, hotspot 310, and home/remote office network 308.

One aspect of the arrangement illustrated in FIG. 4 is that overall control of the content management needs of multiple clients associated with a particular local area network, such as one operated by a home user or a small-office of home office user, can be coordinated through the central website, without necessitating the use, implementation or maintenance, by that network user, of an expensive and complex central management system. Such an arrangement also provides a level of security to the revenue stream realized by the operator of the content management service, as the potential costs to the client associated with a severance of the relation with the content management service may be significant and would likely exceed the costs associated with maintenance of that relation.

Yet another advantage of the configuration illustrated in FIG. 4 relates to computer 312, through which remote access to data associated with one or more related clients of the content management service is achieved. In particular, a user desiring to access data contained, for example, on main office network 200 can readily do so by simply connecting computer 312 with the content management service website 304, at which time various content management operations may be performed. Consequently, any number of remote users can readily avail themselves of desired content and content management functionality. Such a feature may prove particularly useful, for example, in the case of businesses and other enterprises that have employees who frequently travel away from the home office and rely on remote access to content. This feature is also particularly useful to home users who can grant access to local data to trusted third-part users, such as friends or family.

In one such content management operation, the content management service 304 automatically updates the content detected on the remotely connecting computer 312. Similarly, in the event that hotspot 310 is located at a remote location, a user employing hotspot 310 to access and view content can be assured that the accessed content reflects the most up to date content available from the other related clients.

In addition, the content management system 322 implemented within the content management service 304 may additionally include various high level rules concerning operations to be performed with respect to data received from one or more of the clients. By way of example, one such rule may take the form: “In the event content is received at the data management website 304 from client “A,” copy and download such content to client “B.” More generally however, any other rules may be defined that serve to implement, in the client-website environment 302 some or all aspects of the functionality disclosed herein.

In various embodiments of the invention, appliance 104 acts as a firewall. A firewall is generally defined as a system designed to prevent unauthorized access to or from a private network. Firewalls can be implemented in both hardware and software, or a combination of both. For example, firewalls are frequently used to prevent unauthorized remote Internet users from accessing private networks connected to the Internet. All messages entering or leaving the local network pass through the firewall, which examines each message and blocks those that do not meet the specified security criteria.

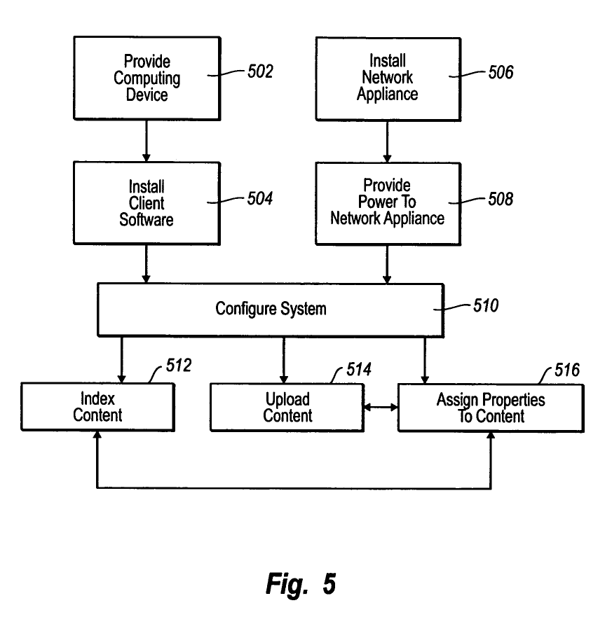

Referring now to FIG. 5, an exemplary method of implementing the invention is depicted therein in block form. Initially, a wireless enabled computing device, such as desktop computer 204 or laptop computer 208 is provided, as indicated by block 502. Client software as described hereinabove is next installed on the computing device, as indicated by block 504. As previously mentioned, the client software enables the wireless systems on the computing device to detect and automatically configure with a wireless-enabled network appliance.

Hence, either before or after the client software is installed on the computing device, a network appliance is placed in wireless range of the computing device and powered on, as indicated by acts 506 and 508. The client software on the client computing device and the content management system on the network appliance then communicate wirelessly to configure their relationship, as indicated by act 510 and described hereinabove. Various acts can occur as part of configuring the computing device with the network appliance, or thereafter as needed or desired. These acts include, for example, creating an index of the content on the computing device on the appliance (act 512), uploading content from the computing device to the appliance for content backup or the creation of shared folders (act 514), and the assignment of properties to the content (such as metadata) that defines the scope of access that others may have to each document or other content that is made network accessible (act 516). As previously noted, the properties assigned to the content may be user selected or assigned by rules governed by a policy engine. For example, content uploaded from an executive's computer may have restricted access defined by the policy engine as a default setting whereas content uploaded from a secretary's computer may have a broader scope of access as a default setting. Further details regarding each of the foregoing acts, and other acts according to the invention, is described in greater detail in other sections of this application.

Embodiments of the invention may be implemented within a variety of different environments. In particular, embodiments of the present invention may be implemented with a special purpose or general purpose computer or other computing device which may or may not comprise a portion of a computer network. A network appliance is an example a computing device. As discussed in greater detail below, such a general purpose computer exemplarily includes various computer hardware. Exemplary embodiments of the present invention also comprise computer-readable media for carrying or having computer-executable instructions or electronic content structures, such as data structures, stored thereon.

Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or electronic content structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and content which cause a general purpose computer, special purpose computer, or special purpose local processing device to perform a certain function or group of functions.

The following discussion provides a brief, general description of an exemplary computing environment in which the invention may be implemented. Although not required, aspects of the invention may be described in the general context of computer-executable instructions, such as program modules, being executed by computers in network environments.

Generally, program modules include routines, programs, objects, components, and content structures that perform particular tasks or implement particular abstract content types. Computer-executable instructions, associated content structures, and program modules represent examples of the program code means for executing steps of the methods disclosed herein. The particular sequence of such executable instructions or associated content structures represent examples of corresponding acts for implementing the functions described in such steps.

Of course, the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a client network. In a distributed computing environment for example, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A content management system comprising:
a network appliance configured to be deployed in a local area network and/or remote office network, wherein the appliance is configured to communicate with a computing device in the corresponding network and the appliance includes, or accesses, various systems, software and devices that facilitate content management within the corresponding network; and
a computer readable medium carrying computer executable instructions which enable the computing device to, upon placement of the network appliance in communication with the computing device, identify the network appliance and enable the network appliance to access selected content on the computing device.

2. A system as in claim 1, wherein the network appliance is enabled to copy selected content from the computing device to the network appliance such that the content is made accessible to other users on the network or remote users.

3. A system as in claim 1, wherein the network appliance is placed in communication with the computing device via wireless communication systems on each of the network appliance and the computing device.

4. A system as in claim 1, wherein the appliance has an associated database and policy engine that incorporates various rules for the handling of content created on, or sent to, the appliance.

5. A system as in claim 4, wherein the various rules relate to one or more of the distribution, storage, sharing, and secure and reliable backup of content, on both local and remote devices.

6. A system as in claim 4, wherein the appliance is configured to create, update, and maintain databases located at remote locations, and also to permit remote users to access local content, either directly or by way of an Internet-based service.

7. A system as in claim 1, wherein the network appliance further performs a function selected from the group consisting of: content backup with multiple versions; content sharing with user-selected accessibility; and content indexing.

8. A system as in claim 1, wherein the network appliance further performs a function selected from the group consisting of: firewall services; network computing device diagnostics and monitoring, network use statistics, and usage reporting.

9. A system as in claim 1, further comprising a remote content management service, wherein the remote content management service is configured to communicate with and interface between the network appliance and remote users and/or systems such that the remote users and/or systems can access content stored on the network appliance.

10. A system as in claim 9, wherein the remote content management service enables remote users and systems to gain remote access to the computing device.

11. A system as in claim 9, wherein the remote content management service provides a function selected from the group consisting of: content backup with versions and remote content sharing.

12. A system as in claim 9, wherein the remote content management service contains a content index of the content on the computing device, wherein the content index is accessible by authorized remote users and/or systems.

13. A content management system comprising:
a wireless enabled network appliance configured to be deployed in a local area network, wherein the appliance facilitates content management within the network;
a wireless enabled computing device, wherein the computing device comprises a computer readable medium carrying computer executable instructions which enable the computing device to, upon placement of the network appliance in wireless range of the computing device, provide permission to the network appliance to access selected content on the computing device; and
a remote content management service, wherein the remote content management service is configured to communicate with and interface between the network appliance and remote users and/or systems such that the remote users and/or systems can access content stored on the network appliance and/or the computing device.

14. A system as in claim 13, wherein the remote content management service provides a function selected from the group consisting of: content backup with versions and remote content sharing.

15. A system as in claim 13, wherein the network appliance is enabled to copy selected content from the computing device such that the content is made accessible to other users on the network or remote users.

16. A system as in claim 13, wherein the permission is provided automatically with no user input.

17. A system as in claim 13, wherein the appliance(s) has an associated database and policy engine that incorporates various rules for the handling of content created on, or sent to, the network.

18. A system as in claim 17, wherein the various rules relate to one or more of the distribution, storage, sharing, and secure and reliable backup of such content, on both local and remote devices.

19. A system as in claim 13, wherein the appliance is configured to create, update, and maintain databases located at remote locations.

20. A system as in claim 13, wherein the network appliance further performs a function selected from the group consisting of: content backup with multiple versions; content sharing with user-selected accessibility; and content indexing.

21. A system as in claim 13, wherein the network appliance further performs a function selected from the group consisting of: firewall services; network computing device diagnostics and monitoring, network use statistics, and usage reporting.

22. A method for providing automated data storage and file sharing services, the method comprising the acts of:
providing a wireless-enabled computing device within a local area network;
installing software on a computing device, the software enabling the computing to engage in wireless communications with a content management network appliance; and
placing a content management network appliance within wireless range of the wireless-enabled computing device, whereby the wireless-enabled computing device and the content management network appliance automatically initiate communication with each other.

23. A method as in claim 22, wherein the content management network appliance automatically inventories the computing device to identify data to be backed-up and/or made available to other users or systems.

24. A method as in claim 22, wherein the computing device automatically identifies to the network appliance data to be backed-up and/or made available to other local users or systems and/or remote users or systems.

25. A method as in claim 22, further comprising the act of backing up data from at least one of the wireless-enabled computing devices onto a storage medium on the network appliance.

26. A method as in claim 25, wherein the backed up copy of the data on the network appliance has metadata associated with it that identifies which users may access the data.

27. A method as in claim 22, wherein the network appliance further coordinates the act of backing up data from the computing device onto a remote storage medium.

28. A method as in claim 22, wherein data that is backed up on the network appliance is selectively available to be shared between client computers, wherein the degree of availability may be selected by a user.

29. A method as in claim 22, wherein the network appliance provides connectivity to the Internet and data sharing and redundancy services between the local area network and a remote service, remote computers, and/or remotes systems.

30. In a computing network, a computer program product for implementing a method suitable for use on a wireless enabled computing device in a local area network, the computer program product comprising:
a computer readable medium carrying computer executable instructions for performing the method, wherein the method comprises:
configuring wireless systems on the computing device to monitor for a wireless enabled network appliance;
upon the wireless system on the computing device identifying a wireless enabled network appliance, verifying whether the network appliance has permission to access the computing device; and
upon verifying that the wireless enabled network appliance has permission to access the computing device, providing access to selected content on the computing device to the network appliance.
